(19) United States
(12) Patent Application Publication
(10) Pub. No.: US 2010/0029343 A1
(43) Pub. Date: Feb. 4, 2010

(54) MOBILE COMMUNICATING TERMINAL AND METHOD FOR SWITCHING BETWEEN NORMAL MODE AND HANDS-FREE MODE THEREOF

(75) Inventor: Guang-Yu Pei, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/344,461

(22) Filed: Dec. 27, 2008

(30) Foreign Application Priority Data
Jul. 31, 2008 (CN) 200810303260.0

(51) Int. Cl. H04M 1/253

(52) U.S. Cl. 455/569.1

(57) ABSTRACT

A mobile communicating terminal includes a primary transducer, a secondary transducer and a controlling unit. The primary transducer is used for outputting audible sounds in the normal mode. The secondary transducer is used for outputting audible sounds in the hands-free mode, whose output power is different from the primary transducer. The controlling unit is used for automatically changing the mobile communicating terminal between the normal mode and the hands-free mode according to a current reflection distance and a predetermined reflection distance. A method for switching the mobile communicating terminal between the normal mode and the hands-free mode is also provided.

### BACKGROUND

1. Technical Field

The present disclosure relates to a mobile communicating terminal, and particularly to a mobile communicating terminal capable of switching between a normal mode and a hands-free mode and a method thereof.

2. General Background

Mobile phones are popular and convenient, especially as a conversational tool.

In some cases where the user of the mobile phone is driving, it is inconvenient for the user to hold the mobile phone to his or her ear. Mobile phones can be considered as having two modes: a normal mode and a hands-free mode. Most of the mobile phone manufacturers configure a hands-free button on the mobile phones. As a result, when the mobile phone is used to communicate, pressing the button can change the mobile phone between the normal mode and the hands-free mode. Hence, in order to perform this function, the hands-free button must be manually pressed, it is not automatic.

According to this, it is necessary to provide a mobile communicating terminal and method to overcome the aforementioned deficiencies.

### SUMMARY

A mobile communicating terminal capable of switching between a normal mode and a hands-free mode automatically, includes a primary transducer, a secondary transducer, and a controlling unit. When a distance between the mobile communicating terminal and an object is within a predetermined distance, the controlling unit switches the mobile communicating terminal to the normal mode, and the primary transducer is selected for outputting audible sounds correspondingly. When the distance is greater than the predetermined distance, the controlling unit switches the mobile communicating terminal to the hands-free mode, and the secondary transducer is selected for outputting audible sounds correspondingly.

A method for automatically switching a mobile communicating terminal between a normal mode and a hands-free mode is also provided.

Other advantages and novel features will become more apparent from the following detailed description of preferred embodiments when taken in conjunction with the accompanying drawings.

### BRIEF DESCRIPTION OF THE DRAWINGS

FIG. 1 is a functional diagram of a mobile communicating terminal according to an exemplary embodiment.

FIG. 2 is a schematic view of the mobile communicating terminal of FIG. 1.

FIG. 3 is a schematic view of the mobile communicating terminal of FIG. 2 measuring a distance between the mobile terminal and an object.

FIG. 4 is a flow chart illustrating a method for automatically switching a mobile communicating terminal between a normal mode and a hands-free mode according to an exemplary embodiment.

### DETAILED DESCRIPTION OF THE EMBODIMENT

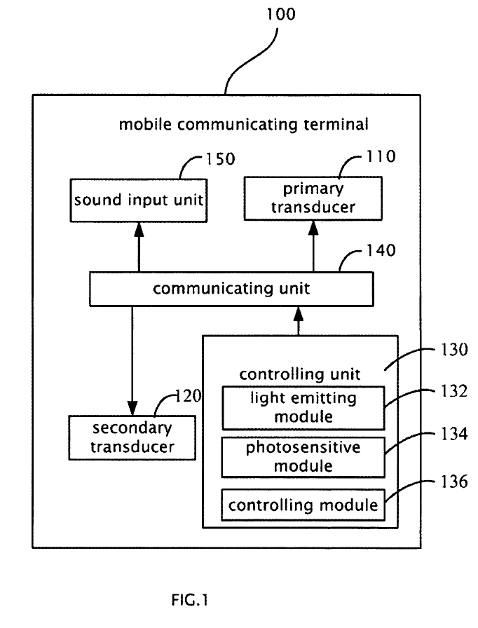

Referring to FIG. 1, a mobile communicating terminal 100 according to an exemplary embodiment is illustrated. In this embodiment, the mobile communicating terminal 100 is a mobile phone. The mobile communicating terminal 100 includes a primary transducer 110, a secondary transducer 120, a controlling unit 130, a communicating unit 140, and a sound input unit 150.

The primary transducer 110 is used for outputting audible sounds when the mobile communicating terminal 100 is in a normal mode (first mode). The primary transducer 110 can also be seen as the primary speaker. The secondary transducer 120 (or secondary speaker) is used for outputting audible sounds when the mobile communicating terminal 100 is in a hands-free mode (second mode). The secondary transducer 120 has an output power that is different from the primary transducer 110. In one embodiment, the output power of the secondary speaker is greater than the primary speaker.

The controlling unit 130 is used for automatically changing a current mode of the mobile communicating terminal 100 between the normal mode and the hands-free mode according to a current state of the mobile communicating terminal 100. The current state depends on a current reflection distance and a predetermined reflection distance stored in the mobile communicating terminal 100. When the current reflection distance is determined to be less than or equal to the predetermined reflection distance, the controlling unit 130 switches the mobile communicating terminal 100 to the normal mode, and the primary transducer 110 is selected for outputting audible sounds correspondingly. When the current reflection distance is determined greater than the predetermined reflection distance, the controlling unit 130 switches the mobile communicating terminal 100 to the hands-free mode, and the secondary transducer 120 is selected for outputting audible sounds correspondingly.

The communicating unit 140 is used for selecting the primary transducer 110 to output audible sounds in the normal mode, and selecting the secondary transducer 120 to output audible sounds in the hands-free mode.

The sound input unit 150 is used for receiving audible sound inputs. In one embodiment, the sound input unit 150 is a microphone for receiving audible sound inputs.

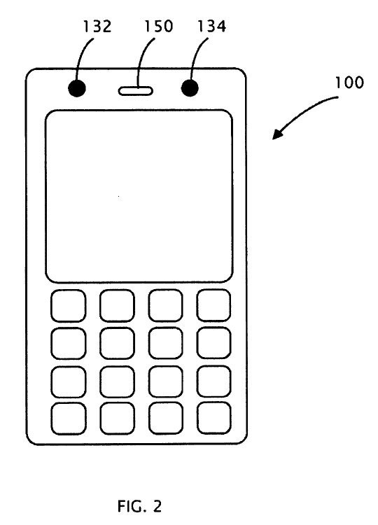

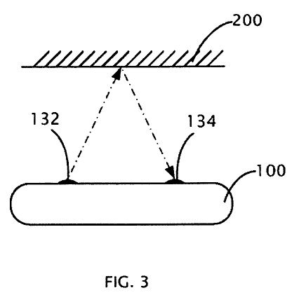

Further referring to FIG. 2 and FIG. 3 together with FIG. 1, the controlling unit 130 includes a light emitting module 132, a photosensitive module 134 and a controlling module 136. The light emitting module 132 is configured for outputting light at predetermined wavelength. In this embodiment, the light emitting module 132 is an infrared light emitting diode.

Correspondingly, the photosensitive module 134 is an infrared photodiode detector. The photosensitive module 134 is configured for receiving light reflected off an object 200 (such as the face or head), and sending an electric current to the controlling module 136 according to an intensity of reflected light. Because light reflected off the object 200 to the photosensitive module 134 has a different intensity based on the distance between the object and the mobile communication terminal 100, the electric current varies when the mobile communication terminal 100 is moved close to or away from the object 200.

The controlling module 136 is configured for determining if the electric current is greater than or equal to a predetermined value. If the electric current is greater than or equal to a predetermined value, it is determined that the reflection distance of light is within a predetermined reflection distance, thus, a first control signal is generated for switching the mobile communicating terminal to the normal mode. If the electric current is less than the predetermined value, it is determined that the reflection distance of light is greater than a predetermined reflection distance, thus a second control signal is generated for switching the mobile communicating terminal to the hands-free mode. It should be noted that the predetermined reflection distance is modifiable according to the user's preference.

In this embodiment, the light emitting module 132 and the photosensitive module 134 are all mounted on the front surface of the mobile communicating terminal 100 (see FIG. 2).

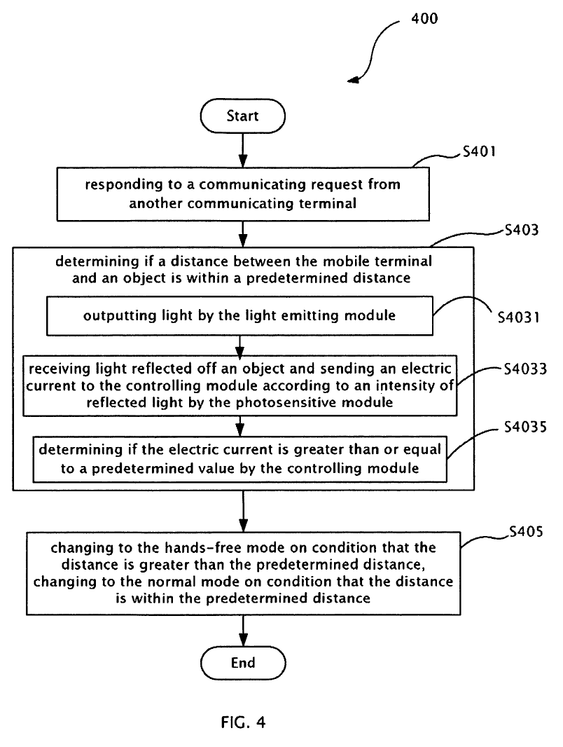

FIG. 4 is a flow chart illustrating a method 400 for automatically switching a mobile communicating terminal between a normal mode and a hands-free mode according to an exemplary embodiment of the present disclosure. The method 400 may be implemented using the mobile communicating terminal 100 (see FIG. 1). The various actions in the method 400 may be performed in the order presented, or may be performed in a different order. Furthermore, in some embodiments, some actions listed in FIG. 4 may be omitted from the method 400. The method 400 includes the following steps.

In step S401, the mobile communication terminal responds to a communicating request from another communicating terminal.

In step S403, determining if a distance between the mobile terminal and an object is within a predetermined distance. This action is performed by a light emitting module, a photosensitive module, and a controlling module. This step also includes the following sub-steps: in sub-step S4031, outputting light by the light emitting module; in sub-step S4033, receiving light reflected off an object and sending an electric current to the controlling module according to an intensity of reflected light by the photosensitive module, and in sub-step S4035, determining if the electric current is greater than or equal to a predetermined value by the controlling module, If the electric current is greater than or equal to a predetermined value, it is determined that the reflection distance of light is within a predetermined reflection distance. If the electric current is less than the predetermined value, it is determined that the reflection distance of light is greater than a predetermined reflection distance.

In step S405, changing to the hands-free mode on condition that the distance is greater than the predetermined distance, changing to the normal mode on condition that the distance is within the predetermined distance.

Using the above mobile communicating terminal and method during a phone conversation, the mobile communicating terminal can automatically changes its operation mode according to a current state of the mobile communicating terminal.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the disclosure.

What is claimed is:

1. A mobile communicating terminal capable of switching between a normal mode and a hands-free mode automatically, the mobile communicating terminal comprising:
a primary transducer for outputting audible sounds in the normal mode;
a secondary transducer for outputting audible sounds in the hands-free mode, the secondary transducer having a different output power from the primary transducer; and
a controlling unit for automatically changing the mobile communicating terminal between the normal mode and the hands-free mode according to a current reflection distance and a predetermined reflection distance;
wherein when the current reflection distance is determined to be less than or equal to the predetermined reflection distance, the controlling unit switches the mobile communicating terminal to the normal mode, when the current reflection distance is determined greater than the predetermined reflection distance, the controlling unit switches the mobile communicating terminal to the hands-free mode.

2. The mobile communicating terminal according to claim 1, further comprising a communicating unit, the communicating unit being configured for selecting the primary transducer to output audible sounds in the normal mode, and selecting the secondary transducer to output audible sounds in the hands-free mode.

3. The mobile communicating terminal according to claim 1, further comprising a sound input unit, the sound input unit being configured for receiving audible sound inputs.

4. The mobile communicating terminal according to claim 1, wherein the controlling unit comprises a light emitting module, a photosensitive module, and a controlling module; wherein the light emitting module is configured for outputting light at predetermined wavelength, the photosensitive module is configured for receiving light reflected off an object, and sending an electric current to the controlling module according to an intensity of reflected light, the controlling module is configured for determining if the electric current is greater than or equal to a predetermined value, if the electric current is greater than or equal to a predetermined value, a first control signal is generated for switching the mobile communicating terminal to the normal mode, if the electric current is less than the predetermined value, a second control signal is generated for switching the mobile communicating terminal to the hands-free mode.

5. The mobile communicating terminal according to claim 4, wherein the light emitting module is an infrared light emitting diode.

6. The mobile communicating terminal according to claim 4, wherein the light emitting module and the photosensitive module are mounted on the front surface of the mobile communicating terminal.

7. A method for automatically switching a mobile communicating terminal between a normal mode and a hands-free mode, the method comprising:
responding to a communicating request from another communicating terminal;
determining if a distance between the mobile terminal and an object is within a predetermined distance; and
changing to the hands-free mode on condition that the distance is greater than the predetermined distance, changing to the normal mode on condition that the distance is within the predetermined distance.

8. The method according to claim 7, wherein the step of determining a distance between the mobile terminal and an object is performed by a light emitting module, a photosensitive module, and a controlling module.

9. The method according to claim 8, further comprising:
outputting light by the light emitting module;
receiving light reflected off an object and sending an electric current to the controlling module according to an intensity of reflected light by the photosensitive module;
determining if the electric current is greater than or equal to a predetermined value by the controlling module.

10. The method according to claim 8, wherein the light emitting module is an infrared light emitting diode.

11. The method according to claim 8, wherein the light emitting module and the photosensitive module are mounted on the front surface of the mobile communicating terminal.

12. A mobile communicating terminal capable of outputting audible sounds in a first mode and a second mode, the mobile communicating terminal comprising:
a primary speaker for outputting audible sounds in the first mode;
a secondary speaker having a different output power from the primary speaker for outputting audible sounds in the second mode;
a light emitting module capable of outputting light;
a photosensitive module capable of receiving light reflected off an object, and sending an electric current according to an intensity of reflected light; and
a controlling module capable of determining if the electric current is greater than or equal to a predetermined value;
wherein if the electric current is greater than or equal to a predetermined value, a first control signal is generated for switching the mobile communicating terminal to the first mode, if the electric current is less than the predetermined value, a second control signal is generated for switching the mobile communicating terminal to the second mode.

13. The mobile communicating terminal according to claim 12, further comprising a communicating unit, the communicating unit being configured for selecting the primary speaker to output audible sounds in the first mode, and selecting the secondary speaker to output audible sounds in the second mode.

14. The mobile communicating terminal according to claim 12, further comprising a sound input unit, the sound input unit being configured for receiving audible sound inputs.

15. The mobile communicating terminal according to claim 12, wherein the output power of the secondary speaker is greater than the primary speaker.

16. The mobile communicating terminal according to claim 12, wherein the light emitting module is an infrared light emitting diode.

17. The mobile communicating terminal according to claim 12, wherein the light emitting module and the photosensitive module are mounted on the front surface of the mobile communicating terminal.
